(19) United States
(12) Patent Application Publication
(10) Pub. No.: US 2005/0230162 A1
(43) Pub. Date: Oct. 20, 2005

(54) Front structure of vehicle

(75) Inventors: Kenji Murayama, Tokyo (JP); Tomoya Iida, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/104,558

(22) Filed: Apr. 13, 2005

(30) Foreign Application Priority Data
Apr. 15, 2004 (JP) 2004-120037

(51) Int. Cl. B60K 11/04

(52) U.S. Cl. 180/68.1

(57) ABSTRACT

A front structure of a vehicle includes a duct having an air inlet portion for introducing air into the duct, a vehicle-body member, a bracket provided on the vehicle-body member in the vicinity of the air inlet portion; and a fitting member provided on the bracket in the vicinity of the air inlet portion; the bracket and the fitting member introducing air to the air inlet portion through a tortuous flow path. Since outside air taken into the vehicle body flows to the air inlet portion through the tortuous flow path, it is possible to avoid the air containing snow or rain directly flowing into the air inlet portion.

### CROSS REFERENCE TO RELATED APPLICATIONS AND INCORPORATION BY REFERENCE

This application is based upon and claims the benefit of priority from the prior Japanese Patent Application No. 2004-120037, filed on Apr. 15, 2004; the entire content of which is incorporated herein by reference.

### BACKGROUND OF THE INVENTION

1. Field of the Invention

The present invention relates to a front structure of a vehicle, in particular a front structure of a vehicle for attaining a good engine performance.

2. Discussion of the Related Art

In the recent years, a supercharger is widely used for an automobile engine. Such vehicle often has a front structure with an inter cooler for cooling intake air heated in the supercharger. The inter cooler is provided in an engine compartment of the vehicle at a front part of the vehicle. For this purpose, an air inlet portion is provided in the front part of the vehicle, a baffle plate is provided between the air inlet portion and the inter cooler. An air intake duct is provided between the baffle plate and a front hood. Outside air is taken into the intake duct while the vehicle is driven, and is transferred to the inter cooler. By this structure, the intake air is cooled down. This front structure of the vehicle is known, for instance, from Japanese Kokai Application 1993-96960.

Moreover, another front structure of a vehicle is known wherein an air inlet portion of the air intake duct, which is an air intake duct for an engine is open in the frontal direction within an engine room of the vehicle. Outside air is taken into the front structure through a front grill and a hole perforated in a bumper. Then, the air in the front structure is introduced to the air intake duct.

The front structure disclosed in Japanese Kokai Patent Application 1993-96960 has the air inlet portion in the front structure which is open in the frontal direction, so that the air flow is taken into the air inlet portion, and the air is efficiently cooled down by the inter cooler.

Snow brown up from the ground when the vehicle is driven in the snow or on a road covered with snow in a cold area, or water drops can be entered into the air intake duct, together with the intake air. When the snow or the waterdrops are frozen in the inter cooler, perfect function of the inter cooler can be lost, and hence the engine performance can be affected.

At the same time, when snow brown up from the ground or waterdrops are taken into the air inlet portion of the air intake duct open toward the front part of the vehicle, the snow or the waterdrops can be taken into the air intake duct. When the snow or waterdrops are attached to a movable part in a throttle chamber such as a throttle valve or an air-flow meter and frozen (icing) therein, it is possible that operational failure is caused and that the engine performance is lowered.

### OBJECT AND SUMMARY OF THE INVENTION

It is therefore an object of the present invention to provide a front structure of a vehicle which can maintain a good engine performance by eliminating effect of snow or raindrops, without the provision of a separate buffer member.

The object of the present invention is attained by a front structure of a vehicle comprising a duct having an air inlet portion for introducing air into the duct, a vehicle-body member, a bracket provided on the vehicle-body member in the vicinity of the air inlet portion; and a fitting member provided on the bracket in the vicinity of the air inlet portion; the bracket and the fitting member introducing air to the air inlet portion through a tortuous flow path.

In the front structure of the vehicle, it is possible that the duct is an air intake duct. The front structure further includes an engine compartment comprising an engine and an air intake system. The air intake duct is situated in the engine compartment and having the air inlet portion opening within the engine compartment. The air intake system connects the air intake duct with the engine, and the bracket and the fitting member introduces an air to the air inlet portion through the tortuous flow path so that the air being transferred to the engine passing through the air intake system.

In the front structure of the vehicle, it is possible that the duct is an air introduction duct for introducing air to an inter cooler.

The object of the present invention is also attained by a front structure of a vehicle comprising a duct having an air inlet portion for introducing air into the duct, a vehicle-body member extending in a widthwise direction of the vehicle, the duct being provided so as to contact the vehicle-body member; a bracket including an installation part and a rear part extending from the installation part in an upper direction, the installation part being fixed to the vehicle-body member, and the rear part shielding a front lower part of the air inlet portion; and a fitting member fixed to the bracket, the fitting member including an extending part which extends in a frontal direction of the vehicle, and a shielding part which shields a front upper part of the air inlet portion, the shielding part being provided in front of the bracket; the bracket and the fitting member forming an air introduction opening extending in a lengthwise direction of the vehicle; the air introduced from a part lower than the shielding part of the fitting member being transferred into a space between the fitting member and the vehicle-body member, the fitting member and the bracket introducing the air through a tortuous flow path to the air inlet portion of the duct through the air introduction opening.

In the front structure of the vehicle, it is possible that the duct is an air intake duct. The front structure further includes an engine compartment comprising an engine and an air intake system, the air intake duct being situated in the engine compartment and having the air inlet portion opening within the engine compartment, the air intake system connecting the air intake duct with the engine. The air in the air intake duct flows to the engine passing through the air intake system.

In the front structure of the vehicle, it is possible that the duct is an air introduction duct for introducing air to an inter cooler.

The first object of the present invention is also attained by a front structure of a vehicle comprising a duct having an air inlet portion for introducing air into the duct; a vehicle-body member extending in a widthwise direction of the vehicle, the duct being provided so as to contact the vehicle-body member; and a fitting member provided in front of the air inlet portion, the fitting member including an installation part fixed to the vehicle-body member, a rear part having an air introduction opening perforated therein at a position corresponding to a front upper part of the air inlet portion, and a shielding part extending from the rear part in a frontal direction of the vehicle, the rear part shielding a front lower part of the air inlet portion, and the shielding part shielding a front upper part of the air inlet portion, the air introduced from a part lower than the shielding part of the fitting member flowing into a space between the fitting member and the vehicle-body member, the fitting member having a tortuous flow path for flow to the air inlet portion of the duct through the air introduction opening.

In the front structure of the vehicle, it is possible that the duct is an air intake duct, and the front structure includes an engine compartment comprising an engine, an air intake system, the air intake duct being situated in the engine compartment having the air inlet portion opening within the engine compartment, the air intake system connecting the air intake duct with the engine, the air being transferred from the inlet portion to the engine passing through the air intake system.

In the front structure of the vehicle, it is possible that the duct is an air introduction duct for introducing air to an inter cooler.

### BRIEF DESCRIPTION OF THE DRAWINGS

A more complete appreciation of the invention and many of the attendant advantages thereof will be readily perceived as the same becomes better understood by reference to the following detailed description when considered in connection with the accompanying drawings, wherein:

FIG. 1 is a perspective view of a vehicle having a front structure as a first embodiment of the present invention;

FIG. 2 is a partial perspective view of a front structure;

FIG. 3 is a partial view of the front structure shown in FIG. 2 seen in the direction of arrow A therein;

FIG. 4 is a partial view of the front structure shown in FIG. 2 seen in the direction of arrow B therein;

FIG. 5 is a cross section of the front structure shown in FIG. 4 obtained by cutting the structure along a line I-I, after a bumper is attached and a front hood is closed;

FIG. 6 is a cross section of the front structure shown in FIG. 4 obtained by cutting the structure along a line II-II, after a bumper is attached and a front hood is closed;

FIG. 7 is a cross section of the front structure shown in FIG. 4 obtained by cutting the structure along a line III-III, after a bumper is attached and a front hood is closed;

FIG. 8 is a cross section of the front structure shown in FIG. 4 obtained by cutting the structure along a line IV-IV, after a bumper is attached and a front hood is closed;

FIG. 9 is a perspective view of a bracket;

FIG. 10 is a perspective view of a bracket; and

FIG. 11 is a cross section of a vehicle having a front structure as a second embodiment of the present invention.

### DETAILED DESCRIPTION OF THE INVENTION

Other features of this invention will become apparent in the course of the following description of exemplary embodiments, which are given for illustration of the invention and are not intended to be limiting thereof

### First Embodiment

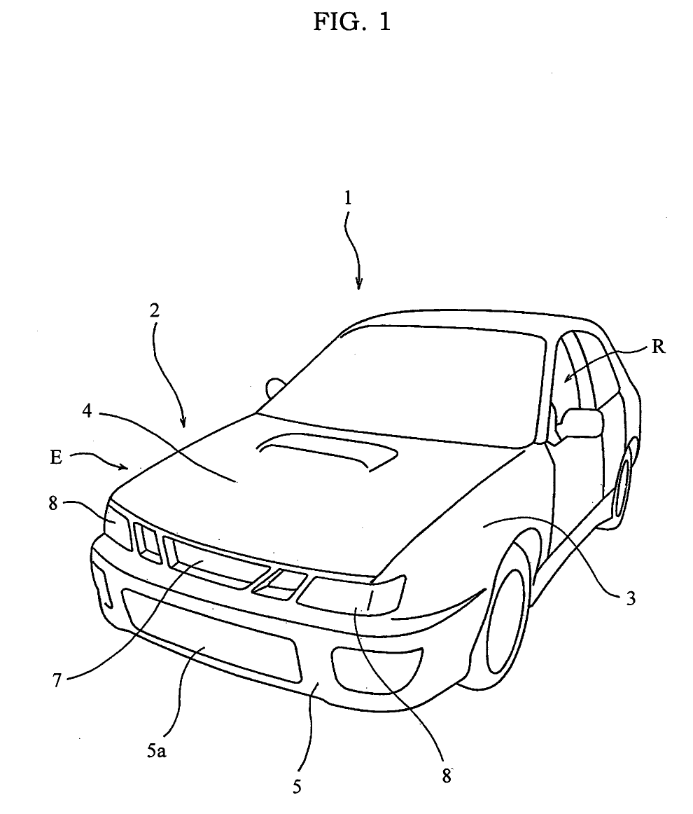

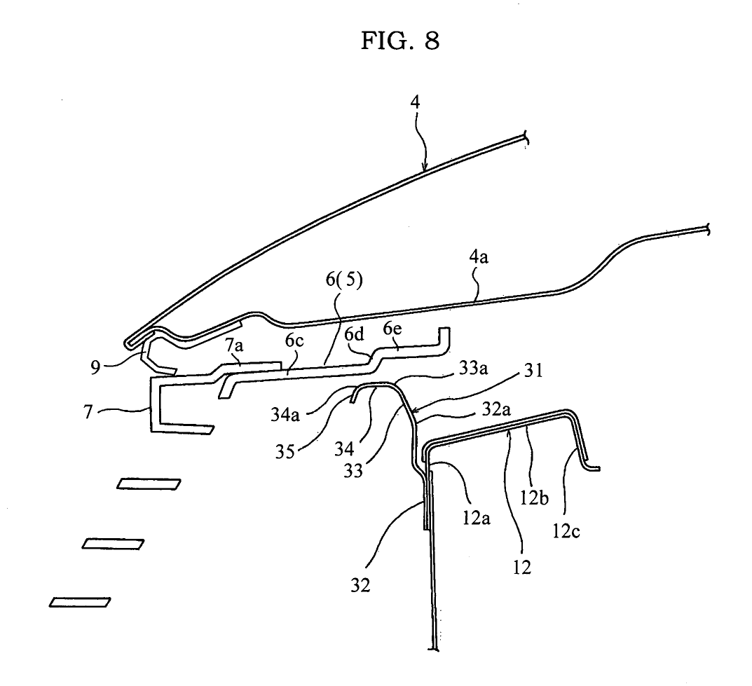

A first embodiment of a front structure of a vehicle according to the present invention will be explained by referring to FIGS. 1 to 10. In the figures, the same reference numerals refer to identical members.

FIG. 1 is a perspective view of a vehicle 1 having a front structure of the present invention. The vehicle 1 has a front part 2; fender panels 3 for forming left and right lateral sides of the front part 2; and a front hood 4 which covers an engine compartment E from the top and can be opened and closed. The vehicle 1 also has a bumper 5 and a front grill 7 formed thereon (fitting members). The bumper 5 extends in a widthwise direction of a vehicle along a front surface of the front part 2. The bumper 5 is provided with an air introduction opening 5a at a lower part thereof. The front grill 7 is located between left and right head lamps 8.

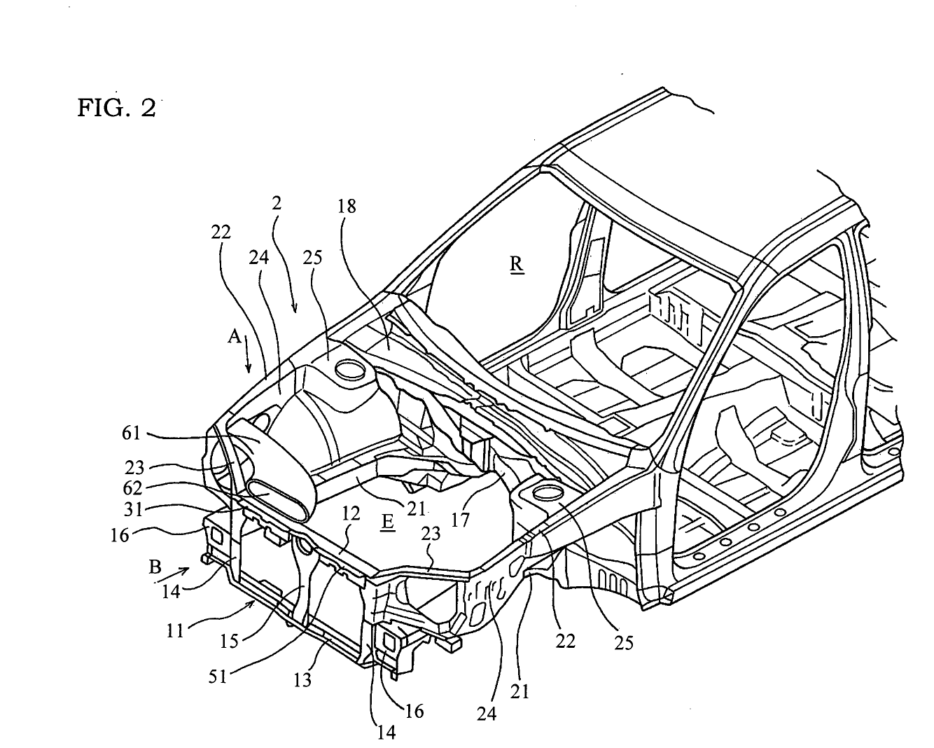

FIG. 2 is a perspective view for explaining the front part 2 of the vehicle 1 with omitting the fender panels 3, front hood 4, bumper 5 and power units such as an engine.

As shown in FIG. 2, the front part 2 of the vehicle 1 includes a radiator panel 11 as a vehicle-body member. The radiator panel 11 is provided at a front end of the engine compartment E with extending in a widthwise direction of the vehicle 1. The radiator panel 11 supports a radiator, shroud, and the like. The radiator panel 11 is in the form of a substantially rectangular frame. The radiator panel 11 is structured from an upper frame member 12 and a lower frame member 13, both extending in a widthwise direction of the vehicle 1, a pair of side frame members 14 vertically extending for linking the ends of the upper and lower frame members 12 and 13 with each other. The radiator panel 11 also includes a center frame member 15 vertically extending between the side frame members 4, so as to connect the upper frame member 12 and the lower frame member 13 at the center of these. Furthermore, frame connecting portions 16 are provided on the side frames 14 so as to protrude in outward directions with respect to the vehicle width. The frame connecting portions 16 are provided at middle parts of the side frames with respect to the vertical direction, on lateral portions of the side frame members 14.

Left and right vehicle body frames 21 and left and right upper side frames 22 (vehicle-body members) are extending in a lengthwise direction of the vehicle body along the lateral sides of the engine compartment E at upper and lower lateral parts thereof. The rear ends of the vehicle body frames 21 and those of the upper side frames 22 are connected to a toe board 17 and a bulkhead 18 which partition a passenger compartment R and the engine compartment E. Front ends of the vehicle body frames 21 are connected to the frame connecting portions 16, so that the vehicle body frames 21 are integrally connected with the radiator panel 11. Moreover, front ends of the upper side frames 22 are connected to upper parts of the radiator panel 11 by way of sub-frames 23.

Between the vehicle body frames 21 and the upper side frames 22, wheel aprons 24 which form lateral walls of the engine compartment E and strut towers 25 for supporting suspensions are provided. Outside the wheel aprons 24 and the strut tower 25 with respect to the vehicle width, the fender panels 3 are provided (FIG. 1). The headlamps 8 are provided on the sub-frames 23.

Brackets 31 and 51 are provided on the upper frame member 12 of the radiator panel 11 at the ends thereof with respect to the widthwise direction of the vehicle 1. The bumper 5 is attached on the front surface of the front part 2 of the vehicle, as mentioned previously. The lower part of the bumper 5 is fixed to the left and right front ends of vehicle body frames 21, and the upper part is fixed to the brackets 31 and 51.

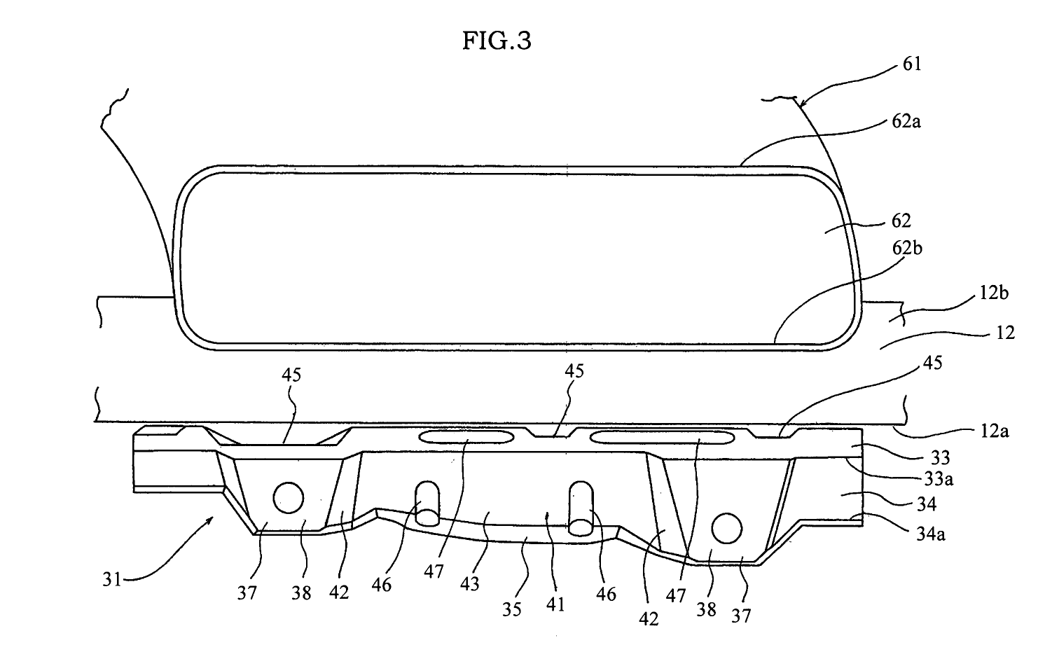

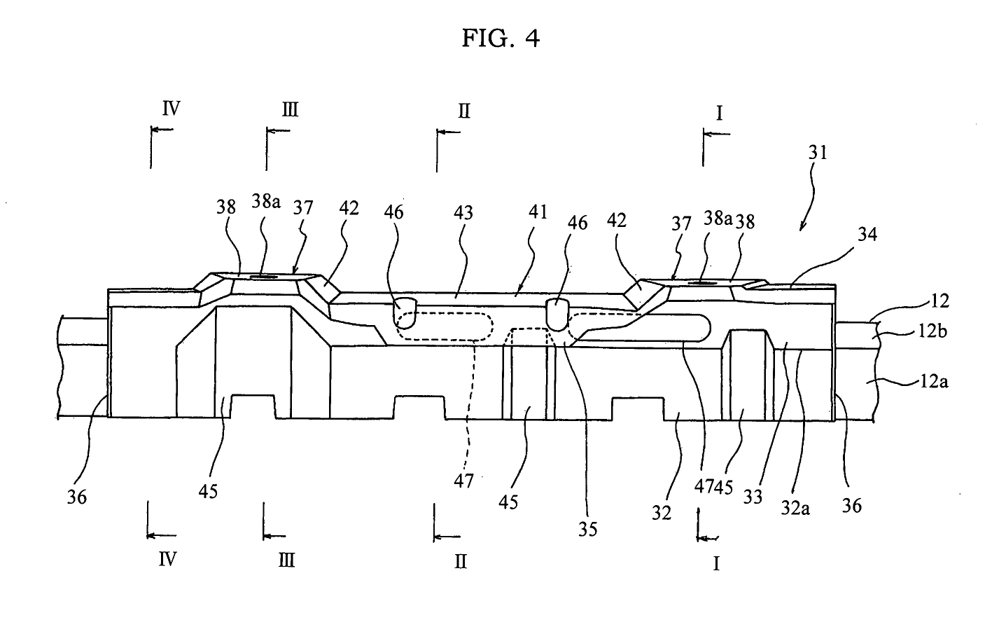

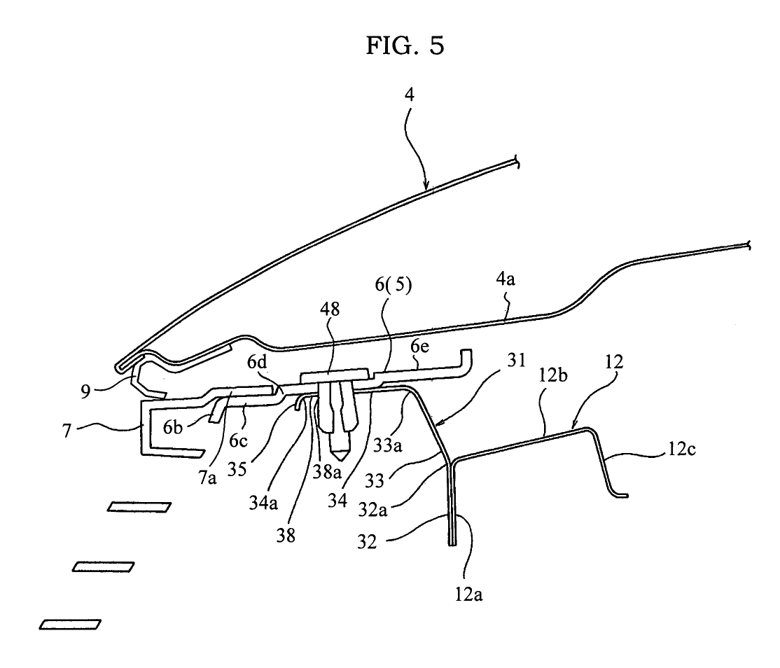

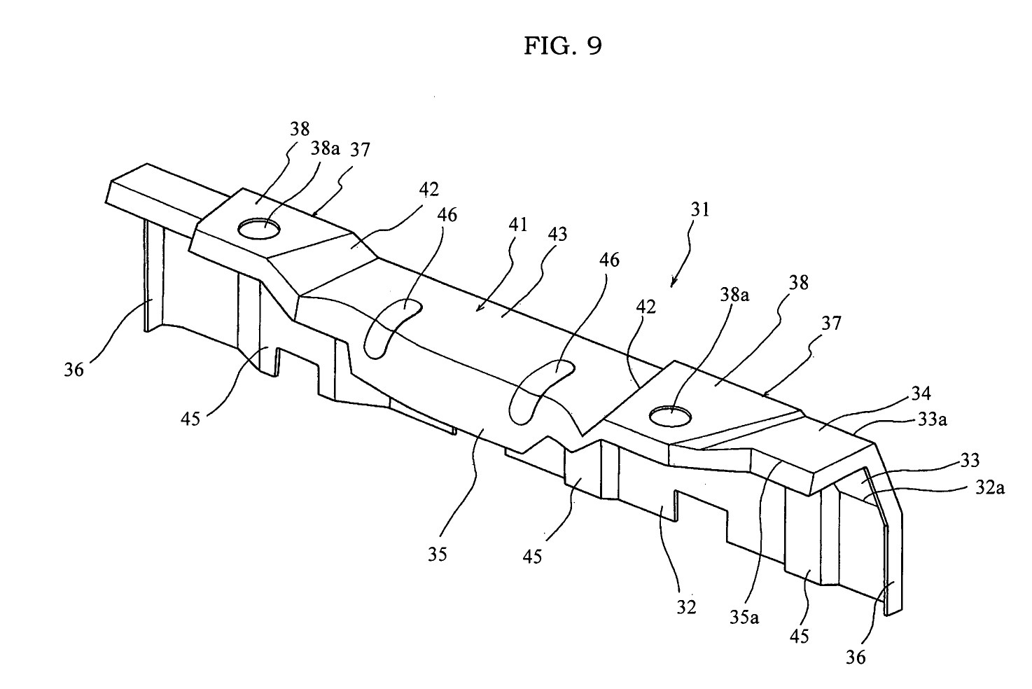

The bracket 31 will be further explained with reference to FIG. 2 to FIG. 9. FIG. 3 is a partial view of the front structure shown in FIG. 2 seen in the direction of arrow A therein, FIG. 4 is a partial view of the front structure shown in FIG. 2 seen in the direction of arrow B therein. FIGS. 5 to 8 are cross sections of the front structure shown in FIG. 4 when the bumper is attached and the front hood is closed, respectively obtained by cutting the structure along lines I-I, II-II, III-III, and IV-IV. Moreover, FIG. 9 is a perspective view of the bracket 31.

As shown in FIGS. 5 to 8, the upper frame member 12 extends in the widthwise direction of the vehicle, having a cross section approximately in the form of a U-shape, made by a front surface 12a, an upper surface 12b and a rear surface 12c. The U-shaped bracket is open in the lower direction. The bracket 31 is attached on the front surface 12a of the upper frame member 12. The upper frame member 12 functions as a buffer plate for interrupting an intake air to be introduced to an air inlet portion of an air intake duct which will be explained later.

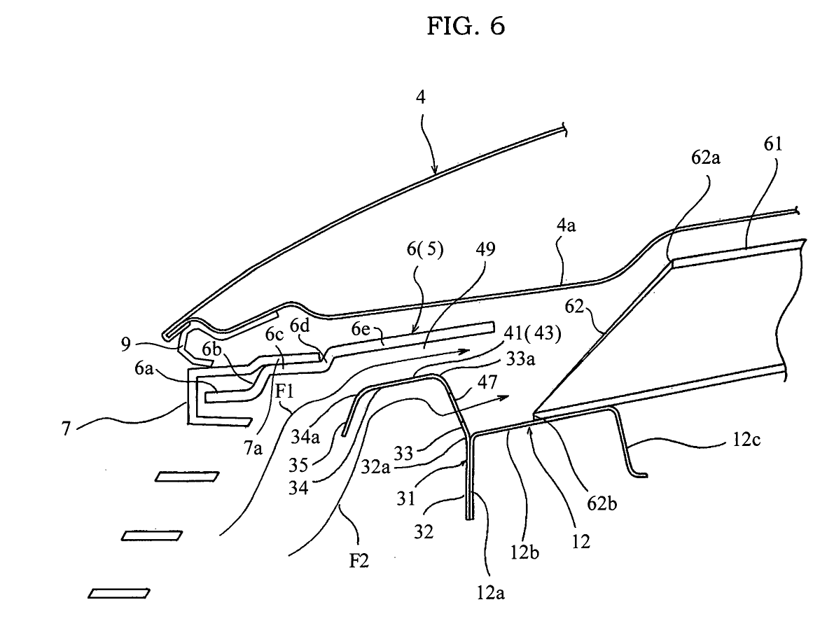

The bracket 31 extends in the widthwise direction of the vehicle along the front surface 12a of the upper frame member 12. The bracket 31 has a cross section approximately in the form of C or U shape successively containing an installation part 32, a rear part 33, an upper part 34, and a front part 35 which are integral with each other. The bottom of the bracket 31 is open. The installation part 32 is in the form of an approximately rectangular plate and attached to the front surface 12a of the upper frame member 12. An upper end 32a of the installation part 32 provided approximately at the same height with an upper end of the front surface 12a of the upper frame member 12, namely with the upper surface 12b. The rear part 33, which is in the form of an approximately rectangular plate, extends from the upper end 32a of the bracket 31 with inclination in an upper and front direction of the vehicle. The rear part 33 shields a front lower area of the air inlet portion 62 or the air intake duct 61 (FIG. 6). In other words, the rear part 33 at least partially prevents air from outside of the vehicle from directly flowing into the air inlet portion. The upper part 34 approximately in the shape of a rectangle extends from an upper end 33a of the rear part 33 in a frontal direction of the vehicle 1. Furthermore, the front part 35 in the form of a flange extends from a front end 34a of the upper part 34 by downwardly bending in a frontal direction with respect to the vehicle. As shown in FIG. 9, flanges 36 are formed on the lateral sides of the installation part 32, rear part 33, upper part 34 and front part 35 for increasing the strength of the bracket 31.

FIGS. 3 and 4 show that the bracket 31 has bumper installation parts 37 with flat surfaces 38. The bumper installation parts 37, which protrude from the upper part 34 of the bracket 31, are provided in the vicinity of the left and right ends of the upper part 34. Openings 38a are perforated in the surface 38. Between the bumper installation parts 37, an introduction part 41 in a concaved shape is formed. The concaved shape of the introduction part 41 is formed by the left and right lateral faces and the bottom face 43 therebetween. The width of the bottom face 43 is gradually decreased in a rearward direction, and has an inclination in the lengthwise direction of the vehicle 1 so as to have a rear part of the bottom face 43 higher than the front part thereof A plurality of reinforcing beads 45 with approximately U-shaped cross sections extend from the lower end of the installation part 32 to the rear part 33 of the bracket 31 via the upper end 32a of the installation part 32. The reinforcing beads 45 are formed so as to protrude in a frontal direction of the vehicle 1. The reinforcing beads 45 are provided for increasing the rigidity of the bracket 31 by restraining relative deformation between the installation part 32 and the rear part 33. Moreover, a plurality of reinforcing beads 46 extend over the introduction part 41 to the front part 35. The beads 46 restrain relative deformation between the upper part 34 and the front part 35, so that the rigidity of the upper part 34 and the front part 35 is maintained. The provision of the beads 46 is effective for maintaining the installation/supporting rigidity of the bumper 5.

It is possible to prepare a plurality air introduction opening 47 in the rear part 33 of the bracket 31. In the figures, two air introduction openings, which are elongated air introduction openings 37 having longer axes in a widthwise direction of the vehicle 1, are formed in the rear part 33 of the bracket 31. The air introduction openings 37 are spaced apart from the beads 45, because perforation between the beads 45 gives an extremely small influence to the rigidity of the rear part 33.

The air intake duct 61 is provided on the upper surface 12b of the upper frame member 12 at a part behind the bracket 31. The air inlet portion 62 of the air intake duct 61 is open in the frontal direction of the vehicle 1, and faces to the rear part 33 of the bracket 31. The shape of the air inlet portion 62 is flat with respect to the widthwise direction of the vehicle 1. Furthermore, the opening of the air inlet portion 62 of the air intake duct 61 has a downwardly inclined shape seen from the lateral side. In other words, the air inlet portion 62 has the upper edge 62a behind the lower edge 62b thereof. The frontal end of the air intake duct 61 is placed on the upper surface 12b of the upper frame member 12 and fixed thereto. The basal part of the air intake duct 61 extends to pass through the inside of the upper side frame, and is connected with the air intake system of an engine.

As shown in FIGS. 5 to 8, the upper part 6 of the bumper 5 successively includes a front end part 6a, a gap part 6b, an intermediate part 6c, another gap part 6d and a rear part 6e. The front end part 6a approximately horizontally extends in a backward direction; the gap part 6b upwardly extends from the rear end of the front end part 6a; the intermediate part 6c approximately horizontally extends from the upper end of the gap part 6b in a rearward direction; and the gap part 6d upwardly extends from the rear end of the intermediate part 6c; and the rear part 6e rearwardly extends from the upper part of the gap part 6d. In this way, the upper part 6 of the bumper 5 has a multistage configuration, which plays a role as a buffer plate. An upper end 7a of the front grill 7 is connected to the upper part 6 of the bumper 5 the front part 6a to the intermediate part 6c.

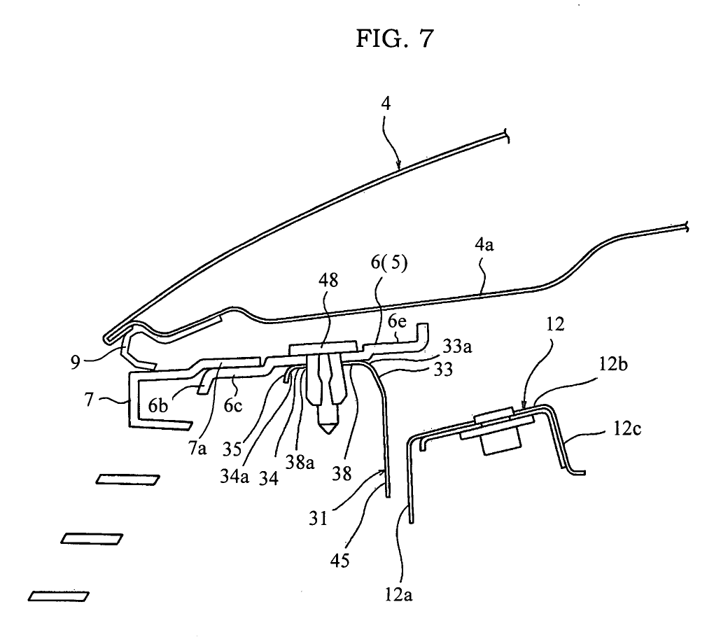

FIGS. 5 and 7 show that the rear part 6e of the bumper 5 is positioned between the flat surfaces 38 of the bumper installation parts 37 provided in the vicinity of the both ends of the bracket 31 on the upper surface thereof. The rear part 6e is placed on the surfaces 38 and fixed thereto by clips 48 inserted to the openings 38a.

By fastening the rear part 6e of the bumper 5 to the bracket 31 as mentioned above, the upper part 6 of the bumper 5 shields the front upper range of the air intake duct 61. By this structure, an air introduction opening 49 is defined by the introduction part 41 of the bracket 31 and the rear part 6e of the bumper 5. The introduction opening 49 has a flat shape and extends in a lengthwise direction of the vehicle 1.

The rear part 6e of the bumper and the upper edge 62a of the air inlet portion 62 are spaced apart from each other. The space is covered by the inner panel 4a of the front hood 4 when the front hood 4 is closed. An inner panel 4a of the front hood 4 makes the air introduction opening 49 extend smoothly. Namely, the front hood 4 supplements the function of the air intake duct 61. Accordingly, the front hood 4, which covers the space between the upper part 6 and the air inlet portion 62, prevents snow or water drops from entering into the air intake duct 61 from the space. Here, the inclined shape of the air inlet portion 62 of the air intake duct 61 is useful for making the front part of the front hood 4 downwardly inclined in a frontal direction of the vehicle. In other words, the limitation to the shape of the vehicle body is softened by the shape of the air intake duct 61.

FIG. 6 shows that outside air is introduced from the front grill 7 and the air introduction opening 5a in the bumper 5 to the part defined by the bumper 5, front grill 7 and radiator panel 11. The air is stagnated and the air flow ratio is decreased by the provision of the air introduction opening 49. Thus, an air introduction path F1 as a torturous flow path is formed, and the air flows from the air introduction opening 49 to the air intake duct 61 through the tortuous flow path.

FIG. 6 also shows that the outside air, which is introduced from the front grill 7 and the air introduction opening 5a in the bumper 5 to the part defined by the bumper 5, front grill 7 and radiator panel 11, is stagnated by the concaved shape of the bracket 31, which is open in a downward direction. Therefore, the flowing rate of the air of decreased. Thus, an air introduction path F2 as a torturous flow path is formed, and the air flows from the air introduction opening 47 to the air intake duct 61 through the tortuous flow path.

Between the front hood 4 and the front grill 7, a sealing rubber 9 is provided. The sealing rubber 9 intercepts the engine compartment E from the external environment, and prevents the outside air from directly flowing into the air inlet portion 62 of the duct 61. Namely, the front part of the air inlet portion 62 is covered by the front hood 4, the sealing rubber 9, the bumper 5, and the upper part of the front grill 7.

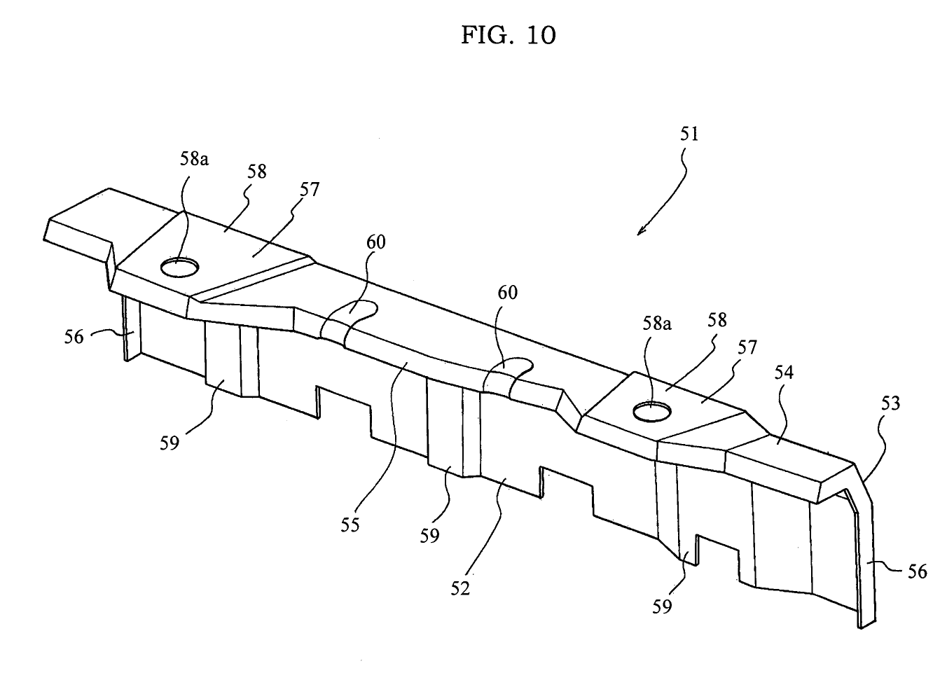

As shown in FIGS. 2 and 10, the bracket 51 extends in the widthwise direction of the vehicle along the front surface 12a of the upper frame member 12. The bracket 51 successively contains an installation part 52, a rear part 53, an upper part 54, and a front part 55 (flange) integrally with each other. The installation part 52 is in the form of an approximately rectangular plate and is connected to the front surface 12a. The rear part 53, which is in the form of an approximately rectangular plate, extends from the upper end of the installation part 52 in an upper and front direction of the vehicle 1. The upper part 54 approximately in a rectangle shape extends from an upper end of the upper part 54 in a lower and frontal direction of the vehicle 1. As shown in FIG. 10, flanges 56 are formed on the lateral sides of the installation part 52, rear part 53, upper part 54 and front part 55 for increasing the strength of the bracket 51.

FIG. 10 shows that bumper installation parts 57 having flat surfaces 58 protrude from the upper part 54 of the bracket 51. The bumper installation parts 57 are provided in the vicinity of the left and right ends of the upper part 54. Openings 58a are perforated in the flat surface 58.

A plurality of reinforcing beads 59 protrudes in a frontal direction of the vehicle over the installation part 52 and the rear part 53. The reinforcing beads 59 are provided for increasing the rigidity of the bracket 5 by restraining relative deformation between the installation part 52 and the rear part 53. Furthermore, a plurality of reinforcing beads 60 is formed from the upper part 54 to the front part 55 in order to restrain the relative deformation between the upper part 54 and the front part 55. Thus, the rigidity of the bracket 51 is increased.

The bumper 5 is provided on the bumper installation parts 57 of the bracket 51. The upper part 6 of the bumper 5 is positioned on the surfaces 58 of the bumper installation parts 57, and then the upper part 6 of the bumper 5 is fixed to the installation parts 57 by inserting clips (not shown) to the openings 58a.

The air introduction path F1 is made from the space between the front part 35 of the bracket 31 and the upper surface 6 of the bumper 5, and the air introduction opening 49 defined by the introduction part 41 of the bracket 31 and the rear part 6e of the bumper 5. Outside air introduced from the front grill 7 and the air introduction opening 5a of the bumper 5 is stagnated and the air flow ratio is decreased by the provision of the air introduction path F1 as a tortuous flow path.

When snow or water drops are entered into the front grill 7 and the air introduction opening 5a of the bumper 5, the snow or water drops has to flow through the tortuous flow path, together with the intake air. Therefore, the water or the water drops is eliminated by the upper part 6 of the bumper, the bracket 31 and the like, so that the amount of water contained in the intake air can be extremely minimized by the way to the air inlet portion 62.

In the front structure of the vehicle 1, the air introduction path F2 is also formed as a tortuous flow path from the bracket 31 in the above-mentioned U shape, and the air introduction opening 47 perforated on the rear part 33 of the bracket 31. Apart of the outside air flows through the air introduction path F2.

When the outside air containing snow or water drops flow to the air intake duct 61 through the air introduction path F2, the water or the water drops is eliminated by the bracket 31 and the bumper 5. Therefore, the amount of water contained in the intake air can be extremely minimized by the way to the air inlet portion 62.

As a result, the water content in the intake air to be supplied from the air intake duct 61 to the intake system of the engine is extremely minimized, and hence it is possible to effectively protect the engine. Namely, movable parts such as a throttle valve and an air flow meter contained in a throttle chamber are protected from icing that is caused, for instance, by the attachment of the water drops and freezing thereof on the movable parts. Namely, it is possible to maintain the engine performance by using the front structure of the vehicle according to the present invention. Moreover, the bumper 5 and the bracket 31 play a role as a buffer, so that it is not necessary to provide a separate buffer, so that it is possible to avoid the increase of the manufacturing cost and the use of complicated structures.

It is possible to omit the formation of the air introduction opening 47 in the rear part 33, when most of the intake air is supplied to the air intake duct 61 through the air introduction path F1.

As mentioned previously, the rear part 33 of the bracket 31 shields a front lower part of the air inlet portion 62. Moreover, a part in the upper part 6 of the bumper 5 (a shielding part of the bumper), which exists in front of the bracket 31 shields a front upper part of the air inlet portion 62. Furthermore, the bumper 5 and the bracket 31 form an air introduction opening 49 which extends in the lengthwise direction of the vehicle 1. The air introduction opening 49 introduces the air, which entered into the front part 2 of the vehicle 1 from a part lower than the shielding part of the bumper, to the air inlet part 62 of the air intake duct 61 through a tortuous flow path.

Based on a requirement as to the design of the vehicle body, such as the change of the vehicle body structure, it is possible to mount the brackets 31 and 51 on sub-frames 23 or the other member of the vehicle body, instead of mounting on the upper frame member 12. Moreover, it is possible to form the air introduction path F1 with the replacement of the bumper 5 by the other fitting members such as the front grill 7.

In the above embodiment, the front structure 2 of the vehicle 1 having an air inlet portion 62 which opens in the frontal direction of the vehicle 1 has been explained. Alternatively, it is possible in the present invention to prepare the air introduction path F1 for an air introduction duct for introducing air to an inter cooler.

### Second Embodiment

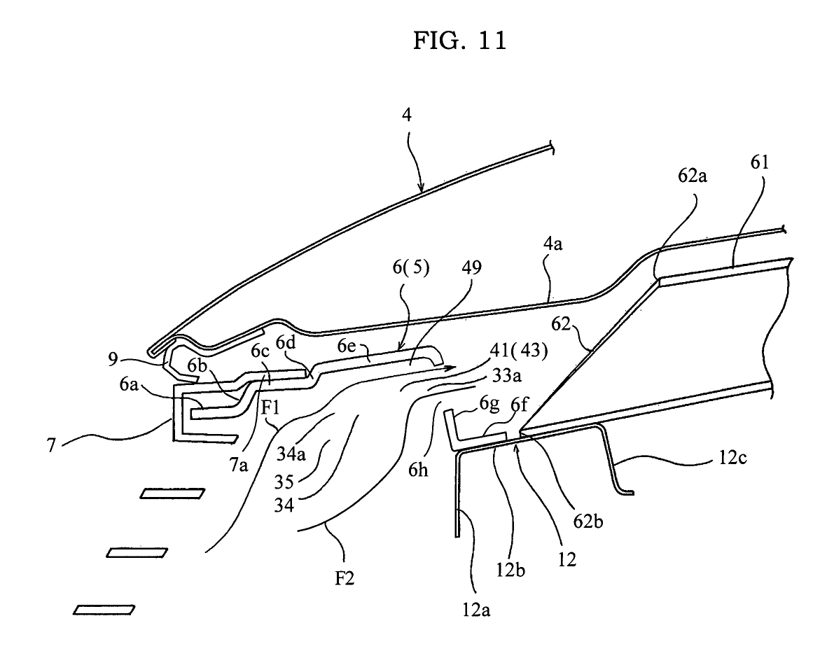

A second embodiment of the front structure of the vehicle according to the present invention will now be explained, by referring to FIG. 11.

FIG. 11 is a cross section of the front structure of the vehicle 1. In the second embodiment, the shape of the bumper 5 (fitting member) is different from that in the first embodiment. The other structures of the second embodiment are the same as those in the first embodiment. Explanation on members or structures in FIG. 11 which correspond to those in FIGS. 1 to 10 is omitted by using the corresponding reference numerals among the figures.

The bumper 5 in the second embodiment includes a back face part 6g and an installation part 6f, in addition to the front end part 6a, the gap part 6b, the intermediate part 6c, the gap part 6d and the rear part 6e. The back face part 6g downwardly extends from the lower end of the rear part 6e, and the installation part 6f extends from the lower end of the back face part 6g. The back face part 6g shields the lower part of the air inlet portion 62 of the air duct 61, and the installation part 6f is fixed to the upper surface 12b of the upper frame member 12. An air introduction opening 6h is perforated in the back face part 6g.

In other words, the back face part 6g, which is provided in front of the air inlet portion 62, shields the air flow to the lower part of the air inlet portion 62. The air introduction opening 6h in the back face part 6g faces the air inlet portion 62, and the upper end of the back face part 6g extends in a frontal direction of the vehicle to the rear part 6e of the upper part 6.

A multistage configuration of the upper part 6 of the bumper 5 is formed by the gap part 6b, the intermediate part 6c, the gap part 6d and the rear part 6e, provided in front of the air introduction opening 6h. After the air is introduced from a part lower than the upper part 6, the upper part 6 of the bumper 5 makes the air stagnate and the flow ratio of the air is decreased since the multistage configuration disturbs a smooth air flow. The air introduction path F3 in the form of a tortuous flow path is formed by the upper part 6 of the bumper having the multistage configuration and the air introduction opening 6a perforated in the back face part 6g. The air flows through the tortuous flow path to the air inlet portion 62 of the air intake duct 61 via the opening 6h.

When snow or water drops entered into a space defined by the bumper 5, front grills 7 and the radiator panel 11, together with the outside air, it is possible to eliminate the snow or water drops by the provision of the air introduction path F3. Therefore, it is possible to make the amount of water contained in the intake air, which is conveyed to the air intake duct 61, is minimized.

By decreasing the water amount in the air transferred to the air intake duct 61, and hence to the intake system of an engine, it is possible to effectively protect movable parts such as a throttle valve and an air flow meter contained in an throttle chamber from icing, that is caused, for instance, by the attachment of the water drops and freezing thereof on the movable parts. Namely, it is possible to maintain the engine performance by using the front structure of the vehicle according to the present invention.

Depending on a requirement as to the design of a vehicle body, it is possible to mount the installation part 6f of the bumper 5 on sub-frames 23 or the other member of the vehicle body, instead of mounting on the upper frame member 12.

In the above embodiment, the front structure 2 of the vehicle 1 having an air inlet portion 62 which opens in the frontal direction of the vehicle 1 has been explained. Alternatively, it is possible in the present invention to prepare the air introduction path F3 for an air introduction duct for introducing air to an inter cooler.

The present invention being thus described, it will be clearly understood that the same may be varied in many ways. Such variations are not to be regarded as a departure from the spirit and scope of the present invention, and all such modification as would be easily understood to one skilled in the art are intended to be included within the scope of the appended claims.

1. A front structure of a vehicle comprising:
a duct having an air inlet portion for introducing air into the duct,
a vehicle-body member,
a bracket provided on the vehicle-body member in the vicinity of the air inlet portion; and
a fitting member provided on the bracket in the vicinity of the air inlet portion; the bracket and the fitting member introducing air to the air inlet portion through a tortuous flow path.

2. The front structure of a vehicle as claimed in claim 1, wherein the duct is an air intake duct, and the front structure includes an engine compartment comprising an engine and an air intake system, the air intake duct being situated in the engine compartment and having the air inlet portion opening within the engine compartment, the air intake system connecting the air intake duct with the engine, the bracket and the fitting member introducing an air to the air inlet portion through the tortuous flow path so that the air being transferred to the engine passing through the air intake system.

3. The front structure of a vehicle as claimed in claim 1, wherein the duct is an air introduction duct for introducing air to an inter cooler.

4. A front structure of a vehicle comprising:
a duct having an air inlet portion for introducing air into the duct,
a vehicle-body member extending in a widthwise direction of the vehicle, the duct being provided so as to contact the vehicle-body member;
a bracket including an installation part and a rear part extending from the installation part in an upper direction, the installation part being fixed to the vehicle-body member, and the rear part shielding a front lower part of the air inlet portion; and
a fitting member fixed to the bracket, the fitting member including an extending part which extends in a frontal direction of the vehicle, and a shielding part which shields a front upper part of the air inlet portion, the shielding part being provided in front of the bracket; the bracket and the fitting member forming an air introduction opening extending in a lengthwise direction of the vehicle; the air introduced from a part lower than the shielding part of the fitting member being transferred into a space between the fitting member and the vehicle-body member, the fitting member and the bracket introducing the air through a tortuous flow path to the air inlet portion of the duct through the air introduction opening.

5. The front structure of a vehicle as claimed in claim 4, wherein the duct is an air intake duct, and the front structure includes an engine compartment comprising an engine and an air intake system, the air intake duct being situated in the engine compartment and having the air inlet portion opening within the engine compartment, the air intake system connecting the air intake duct with the engine, the air being flowing from the inlet portion to the engine passing through the air intake system.

6. The front structure of a vehicle as claimed in claim 4, wherein the duct is an air introduction duct for introducing air to an inter cooler.

7. The front structure of a vehicle as claimed in claim 4, wherein the bracket further comprises an upper part extending from the upper end of the rear part in a frontal direction of the vehicle, the upper part having an installation part for connecting the fitting member thereto, and a front part downwardly extending from the front end of the upper part.

8. The front structure of a vehicle as claimed in claim 4, wherein the rear part of the bracket includes an air introduction opening perforated therein.

9. The front structure of a vehicle as claimed in claim 7, wherein the rear part of the bracket includes an air introduction opening perforated therein.

10. The front structure of a vehicle as claimed in claim 8, wherein the bracket has a reinforcing bead extending from the installation part to the rear part, and the air introduction opening being spaced apart from the bead.

11. The front structure of a vehicle as claimed in claim 9, wherein the bracket has a reinforcing bead extending from the installation part to the rear part, and the air introduction opening being spaced apart from the bead.

12. The front structure of a vehicle as claimed in claim 4, wherein the extending part of the fitting member is in a bent shape so as to have a cross section with a multistage configuration, the extending part being situated in front of the air introduction opening.

13. The front structure of a vehicle as claimed in claim 4, wherein the vehicle-body member is a radiator panel the fitting member is a bumper, and the extending part is the upper part of the bumper.

14. The front structure of a vehicle as claimed in claim 4, wherein a space between the fitting member and an upper end of the air inlet portion is covered by a lower surface of a front hood so as to make the air smoothly flow.

15. A front structure of a vehicle comprising:
a duct having an air inlet portion for introducing air into the duct;
a vehicle-body member extending in a widthwise direction of the vehicle, the duct being provided so as to contact the vehicle-body member; and
a fitting member provided in front of the air inlet portion, the fitting member including an installation part fixed to the vehicle-body member, a rear part having an air introduction opening perforated therein at a position corresponding to a front upper part of the air inlet portion, and a shielding part extending from the rear part in a frontal direction of the vehicle, the rear part shielding a front lower part of the air inlet portion, and the shielding part shielding a front upper part of the air inlet portion, the air introduced from a part lower than the shielding part of the fitting member flowing into a space between the fitting member and the vehicle-body member, the fitting member having a tortuous flow path for flow to the air inlet portion of the duct through the air introduction opening.

16. The front structure of a vehicle as claimed in claim 15, wherein the duct is an air intake duct, and the front structure includes an engine compartment comprising an engine, an air intake system, the air intake duct being situated in the engine compartment having the air inlet portion opening within the engine compartment, the air intake system connecting the air intake duct with the engine, the air being transferred from the inlet portion to the engine passing through the air intake system.

17. The front structure of a vehicle as claimed in claim 15, wherein the duct is an air introduction duct for introducing air to an inter cooler.

18. The front structure of a vehicle as claimed in claim 15, wherein the extending part of the fitting member is in a bent form so as to have a cross section with a multistage configuration, the extending part being situated in front of the air introduction opening.

19. The front structure of a vehicle as claimed in claim 15, wherein the fitting member is a bumper, and the extending part is the upper part of the bumper.

20. The front structure of a vehicle as claimed in claim 15, wherein a space between the fitting member and an upper end of the air inlet portion is covered by a lower surface of a front hood so as to make the air smoothly flow.
